(19) United States
(12) Patent Application Publication
(10) Pub. No.: US 2023/0376434 A1
(43) Pub. Date: Nov. 23, 2023

(54) PLC In-band Control for Wearables and Hearables

(71) Applicant: Google LLC, Mountain View, CA (US)

(72) Inventors: Yuan Jen Chang, Mountain View, CA (US); Shih-hsien Yang, Mountain View, CA (US)

(73) Assignee: Google LLC, Mountain View, CA (US)

(21) Appl. No.: 18/042,557

(22) PCT Filed: Aug. 26, 2020
(86) PCT No.: PCT/US2020/047968

§ 371 Date: Feb. 22, 2023

(51) Int. Cl. G06F 13/20

(52) U.S. Cl. CPC G06F 13/20; G06F 2213/40

(57) ABSTRACT

The present disclosure provides systems and methods for activating a general purpose input/out (“GPIO”) pin. The system may include a control device, agency device, and a controlled device. The agency device may be part of the controlled device or it may be a separate device. The agency device may receive a communication signal transmitted from the control device. The agency device may count the number of pulses during a certain period of time to determine a GPIO pin to trigger on the controlled device.

### BACKGROUND

When transferring signals between two electronic devices, it is preferable to minimize the number of contacts between the devices. For example, reducing the number of pins on charging/data cables for mobile devices, as well as a number of contacts in the mobile devices, helps to provide more room for other technology in the mobile device. This is particularly true for small form factor devices, such as smartwatches, earbuds, Bluetooth headsets, head-mounted displays, etc. Moreover, an increased number of contacts increases the possibility of error and reduces reliability. For example, an increased number of contacts results in an increased probability that one of the contacts will become damaged or worn out or otherwise defective. Additionally, each contact included in a device increases the costs of production of the device. The increased number of contacts may increase the physical size of the device or may require more space within the device which the device may not have space for. However, because various types of signals typically need to be transmitted, such as power signals, data signals, control signals, etc., reducing the number of contacts can be quite challenging.

### SUMMARY

The present disclosure provides systems and methods for detecting the number of control pulses sent within a communication signal over a given period of time to trigger a general-purpose input/output (GPIO) pin on a wearable and/or hearable device. The system may include a control, or primary, device, an agency device, and a controlled, or secondary, device. The agency device may be located within or be part of the controlled device. The agency device may receive the communication signal from the control device and determine which general purpose input/output (“GPIO”) pin to trigger on the controlled device.

One aspect of the disclosure includes a device comprising a detection window counter configured to determine a period of time starting when the device receives an input signal including at least one trigger pulse, a pattern counter configured to determine a number of pulses within the input signal during the period of time, and a signal generator configured to generate, a signal to activate a general-purpose input/output (“GPIO”) pin based on the counted number of pulses within the period of time.

The signal generator may be further configured to generate at least two different signals for activating at least two different GPIO pins based on the different counted number of pulses within the period of time. The period of time may be longer than a predefined minimal low pulse signal width. The minimal low pulse signal width may define a lower threshold for the width of a signal for duly receipt by the device.

The device may be capable of half-duplex or full-duplex communications. In some examples, the device may be capable of half-duplex or full-duplex communications over a communication line used for receiving the at least one trigger pulse signal. The pattern counter may be further configured to determine a pulse width of a pulse within the period of time. The pattern counter may be further configured to determine, based on the pulse width, a maximum quantity of pulses that occur during the period of time. The pulse width may be larger than a whole signal packet.

Another aspect of the disclosure includes a system comprising a control device, a controlled device, and an agency device coupled to the control device and the controlled device. The agency device may include a detection window counter configured to determine a period of time starting when the agency device receives and input signal including at least one trigger pulse from the control device, a pattern counter configured to determine a number of pulses within the input signal during the period of time, and a signal generator configured to generate a signal based on the counted number of pulses within the period of time, wherein the signal is configured to activate a general-purposes input/output pin on the controlled device.

Yet another aspect of the disclosure includes a method comprising, receiving, by an agency device, an input signal from a control device, the input signal including at least one trigger pulse, determining, by the agency device, a period of time starting when the agency device receives the input signal including the at least one trigger pulse, determining, by the agency device, a number of pulses within the input signal during the period of time, and generating, by the agency device and based on the counted number of pulses within the period of time, a signal to activate a general-purposes input/output (“GPIO”) pin at a controlled device.

### BRIEF DESCRIPTION OF THE DRAWINGS

FIG. 1 is an example pictorial diagram of the system according to aspects of the disclosure.

FIG. 2A is a functional block diagram of the system of FIG. 1.

FIG. 2B is a block diagram of the system of FIG. 1.

FIG. 3 is a functional block diagram of an agency device according to aspects of the disclosure.

FIG. 4 is another example pictorial diagram of the system according to aspects of the disclosure.

FIG. 5 is a graphical representation of a communication signal triggering a GPIO pin according to aspects of the disclosure.

FIG. 6 is another graphical representation of a communication signal triggering a GPIO pin according to aspects of the disclosure.

FIG. 7 is a flow diagram according to aspects of the disclosure.

### DETAILED DESCRIPTION

The technology relates generally to a system that detects the number of pulses sent within a communication signal over a given time period to trigger a GPIO pin. The communication signal may be sent from a control device, also referred to herein as a primary device, to an agency device. The control device may be connected to the agency device by any type of connector including POGO pins, GPIO pins, a USB connection cable, such as a USB-C cable, a charging cable, etc. The agency device may be connected to or a part of a controlled device, also referred to herein as a secondary device. Communication signals sent between the control device and the agency device may transmitted over power lines. The power lines may form a half-duplex or full-duplex signal communication system between the agency device and the control device. For example, the agency device and the control device may be capable of half-duplex or full-duplex communications over a communication line used for receiving the at least one trigger pulse signal.

The communication signal sent by the control device may be received by the controlled device and/or the agency device. According to some examples, the agency device may receive the communication signal when there is a trigger pulse, or signal, within the communication signal. In such an example, the agency device may act as a sniffer such that the agency device may perform any functions or actions until the agency device is triggered by a trigger pulse. A trigger pulse may relate to any kind of a signal that fulfils a predefined criterion based on which the detection window counter is configured to determine a start of a period of time for expecting a pattern of pulses for triggering at least one GPIO. The agency device may include a detection window counter, a pattern counter, and a signal generator. The detection window counter may track the window during which the pattern counter detects whether there is at least one predefined trigger pulse within the communication signal. For example, the detection window counter may begin counting a period of time when it detects a trigger pulse with a low pulse duration longer than a minimal signal width. The minimal low pulse signal width may be a lower threshold for the width of a signal for duly receipt by the controlled device. The detection window counter may, in some examples, may be a stand-alone detector that monitors the incoming communication signal. The detection window counter may be triggered from the edge of a regular, or non-trigger, pulse or a trigger-pulse. Once the detection window counter is triggered, the detection window counter may begin counting the signal pulse duration to determine whether the pulse is a trigger pulse. The detection window counter may set a time period for a detection window after detecting a low pulse duration longer than a minimal signal width. According to some examples, the time period of the detection window may be predefined. The pattern counter may detect, or otherwise track, the number of pulses within the communication signal the agency device receives during the detection window.

Based on the number of pulses detected during the detection window, the signal generator may generate a signal to trigger a GPIO pin on the controlled device. For example, if the pattern counter detects one pulse during the detection window, the signal generator may generate a signal that triggers a first GPIO pin on the controlled device. In examples where the pattern counter detects two pulses during the window, the signal generator may generate a signal that triggers a second GPIO pin on the controlled device. In examples where there is a predetermined number of GPIO pins, each pin may be configured for one or more functions. In such an example, the number of pulses detected during the detection window may correspond to a particular function of a GPIO pin. Based on the number of pulses detected, the signal generator may generate a signal to trigger the particular function assigned to the GPIO pin.

Triggering various GPIO pins may allow for the control device to send data and/or instructions to the controlled device. For example, triggering various GPIO pins may allow for the controlled device to enter debug accessory mode (“DAM”). Additionally or alternatively, triggering various GPIO pins may allow for the controlled device to be restarted or updated, depending on the issue with the controlled device. Even further still, triggering various GPIO pins may allow for updates between the control device and the controlled device. In this regard, data may be transmitted over the GPIO pins.

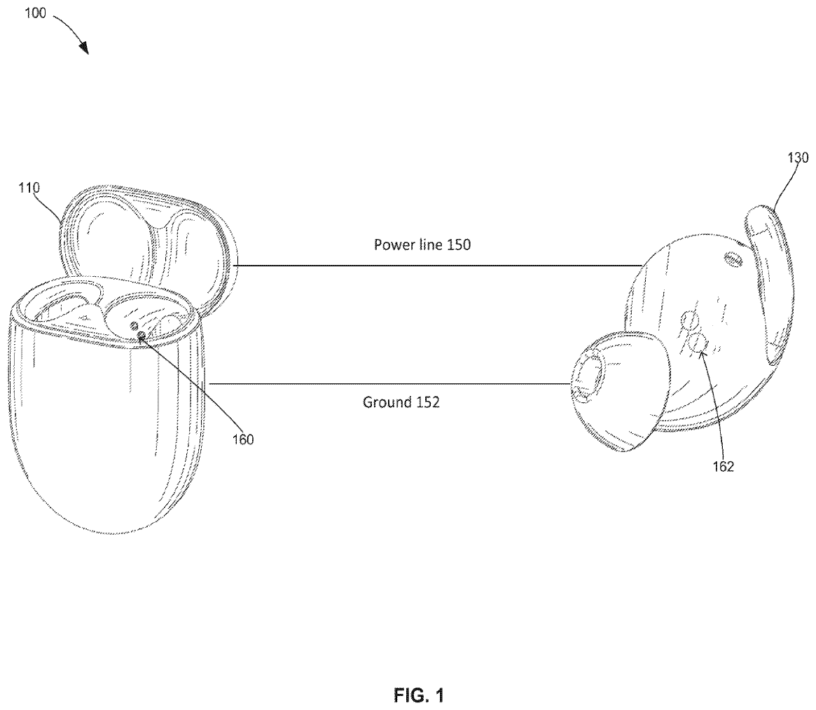

FIG. 1 illustrates a system of example devices in which the features described herein may be implemented. It should not be considered limiting the scope of the disclosure or usefulness of the features described herein. System 100 may include a charging case 110 for a pair of earbuds and one earbud 120 of the pair of earbuds that fit within the charging case. While only one earbud 130 is shown, there may be a second earbud. The charging case 110 may be a control device and the earbud may be a controlled device.

The charging case 110 may be coupled to the earbud 130 via power line 150 and ground line 152. This may allow for full duplex or half duplex communication. While the power and ground lines 150, 152 are shown as respective lines between the two devices, it should be understood that each of the charging case 110 and earbud 130 may include its own power line and ground line, terminating in contacts, and that the electronic coupling of the two devices may be formed when the contacts 160 on the charging case 110 meet the contacts 162 of the earbud 130. Data may be supplied from the charging case 110 to the earbud 130 and from the controlled device 130 to the charging case 110 over the power line 150. The data may include any kind of information, such as battery levels, media playback information, software updates, firmware updates, etc.

The charging case 110 may transmit a communication signal to the earbud 130 via power line 150. The communication signal may include low pulses or high pulses. In some examples, the communication signal may include data and/or control signals. The data signal may be sent in packets.

The charging case 110 may include a microcontroller unit (“MCU”), such as a system on a chip (“SOC”). The MCU of the case 110 may output signals to the earbud 130 when the earbud 230 is docked or coupled to the case 110. According to some examples, the case 110 and the earbud 130 may be capable of full-duplex or half-duplex communications. For example, the case 110 and earbud 130 may be capable of half-duplex or full-duplex communications over a communication line used for receiving the at least one trigger pulse signal. The case 110 and the earbud 230 may be docked or coupled via pins and/or contacts, such as via POGO pins 160 on the case 110 and contacts 162 on earbud 130. While two POGO pins are shown, there may be any number of POGO pins such as one, one, three, four, five, eight, etc. Therefore, the earbuds 130 and the case 110 having two POGO pins each is merely one example and is not intended to be limiting. In some examples, the case 210 and the earbud 230 may be coupled via a defined pin or pins of a USB-C connection cable, charging cable, or other connector. The contacts may connect the case 110 with the agency device 120. The agency device 120 may be connected to the earbud 130 via different and/or separate GPIO pins than the POGO pins 160 connecting the case 110 to contacts 162 of the earbud 130.

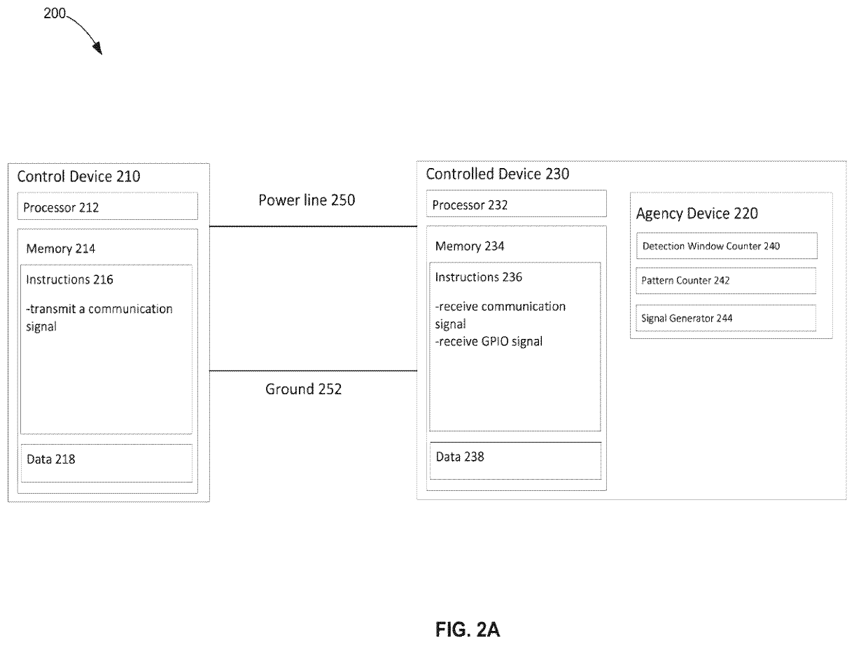

FIG. 2A illustrates a block diagram of example devices of FIG. 1. Control device 210 may contain one or more processors 212, memory 214, instructions 216, and data 218.

The one or more processors 212 may be any conventional processors, such as commercially available microprocessors. Alternatively, the one or more processors may be a dedicated device such as an application specific integrated circuit (ASIC) or other hardware-based processor. Although FIG. 2A functionally illustrates the processor, memory, and other elements of control device 210 as being within the same block, it will be understood by those of ordinary skill in the art that the processor, computing device, or memory may actually include multiple processors, computing devices, or memories that may or may not be stored within the same physical housing. Similarly, the memory may be a hard drive or other storage media located in a housing different from that of control device 210. Accordingly, references to a processor or computing device will be understood to include references to a collection of processors or computing devices or memories that may or may not operate in parallel.

Memory 214 may store information that is accessible by the processors, including instructions 216 that may be executed by the processors 212, and data 218. The memory 214 may be a type of memory operative to store information accessible by the processors 212, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 216 and data 218 are stored on different types of media.

Memory 214 may be retrieved, stored or modified by processors 212 in accordance with the instructions 216. For instance, although the present disclosure is not limited by a particular data structure, the data 218 may be stored in computer registers, in a relational database as a table having a plurality of different fields and records, XML documents, or flat files. The data 218 may also be formatted in a computer-readable format such as, but not limited to, binary values, ASCII or Unicode. By further way of example only, the data 218 may be stored as bitmaps comprised of pixels that are stored in compressed or uncompressed, or various image formats (e.g., JPEG), vector-based formats (e.g., SVG) or computer instructions for drawing graphics. Moreover, the data 218 may comprise information sufficient to identify the relevant information, such as numbers, descriptive text, proprietary codes, pointers, references to data stored in other memories (including other network locations) or information that is used by a function to calculate the relevant data.

The instructions 216 can be any set of instructions to be executed directly, such as machine code, or indirectly, such as scripts, by the processor 212. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

Controlled device 230 may include one or more processors 232, memory 234, instructions 236, and data 238 that are substantially similar to those described herein with respect to control device 210.

Controlled device 230 may receive an input signal, such as the communication signal, transmitted by control device 210 over power line 250. The communication signal may include low pulses or high pulses. In some examples, the communication signal may include data and/or control signals. The data signal may be sent in packets. Although not shown, the control device 210 and/or controlled device 230 may include components to enable the decoding, demodulating, encoding, modulation of the communication signal sent over power line 250. As further described herein, the communication signal may be sent over Universal Asynchronous Receiver/Transmitter (“UART”), or other such data buses or other communication protocols. The agency device 220 may additionally or alternatively detect and/or monitor the communication signal sent over the UART, databuses, etc. for control signals sent from the control device 210 to the controlled device 230.

The communication signal may include data and control signals. The control signal may include a trigger pulse. The trigger pulse may be detected by an agency device 220. According to some examples, the trigger pulse may be a low pulse. While agency device 220 is shown as a component within controlled device 230, agency device 220 may be a stand-alone component such that the agency device 220 is separate from controlled device 230. In some examples, both the controlled device 230 and the control device 210 may include an agency device 220.

The agency device 220 may include a detection window counter 240, a pattern counter 242, and a signal generator 244.

As shown in FIG. 2B, the agency device 220 may be positioned such that it can monitor the communication signals sent between the control device 210 and controlled device 230. In this regard, the agency device 220 may monitor the communication signal for control signals, while allowing the communication signals to pass unimpeded from the control device 210 and controlled device 230, or vice versa.

The detection window counter 240 and pattern counter 242 may receive the low pulse. The detection window counter 240 may begin counting a period of time once the detection window counter 240 receives the low pulse. The period of time may be 3 milliseconds and the minimal signal width may be 500 microseconds. However, in other examples, the period of time may be more of less than 3 milliseconds, such as 1.5, 5, 6, etc. milliseconds and the minimal signal width may be 1, 8.68, 26.04, etc. microseconds. Thus, the period of time being 3 milliseconds and the minimal signal width being 500 microseconds is merely one example and is not meant to be limiting.

Simultaneously or near simultaneously, the pattern counter 242 may begin counting the number of low pulses received during the period of time. The pattern counter 242 may determine whether the low pulse duration is longer than a predefined minimal signal width. Simultaneously or near simultaneously, the pattern counter 242 may begin counting the number of low pulses received during the period of time.

In some examples, the predefined minimal signal width may be longer than the time period to receive a packet transferred between the control device 210 and the controlled device 230 via power line 150 to avoid confusing data signals within control signals or otherwise interrupting data signals. For example, the minimal signal width may be 2 microseconds, the 8-bit packet width may be 20 microseconds, and the in-band control signal width may be 500 microseconds. In such an example, the packet margin may be 250 times greater.

Based on the number of low pulses counted by the pattern counter 242 during the period of time, a signal generator 244 may generate a signal to trigger a certain GPIO pin on controlled device 230. Additionally or alternatively, the signal generated may cause the GPIO pin to perform a certain function.

According to some examples, the functions of the GPIO pins, the GPIO pin(s) to be activated, and/or the pulse pattern or scheme associated for activating at least one GPIO pin of the controlled device may be configurable. For example, the new functions may be defined and/or existing functions may be overwritten, such as by flashing a memory of the controller device and/or the controlled device comprising a list of definitions for the functions and associated patterns.

While not shown, the control device 210 may include an agency device similar to the agency device 220 described above The communication system between the control device 210 and controlled device 230 may include a multiplexer and/or demultiplexer to enable half-duplex or full-duplex communications between the devices.

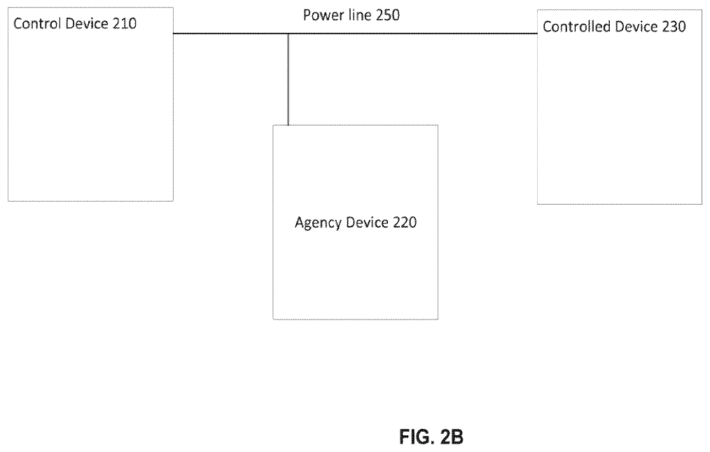

FIG. 3 illustrates another example agency device. Agency device 320 may include one or more processors 322, memory 324, instructions 326, and data 328 that are substantially similar to those described herein with respect to control device 210. The processors 322, memory 324, instructions 326, and data 328 may perform the same or substantially the same functions as the detection window counter 240, a pattern counter 242, and a signal generator 244 described in FIG. 2.

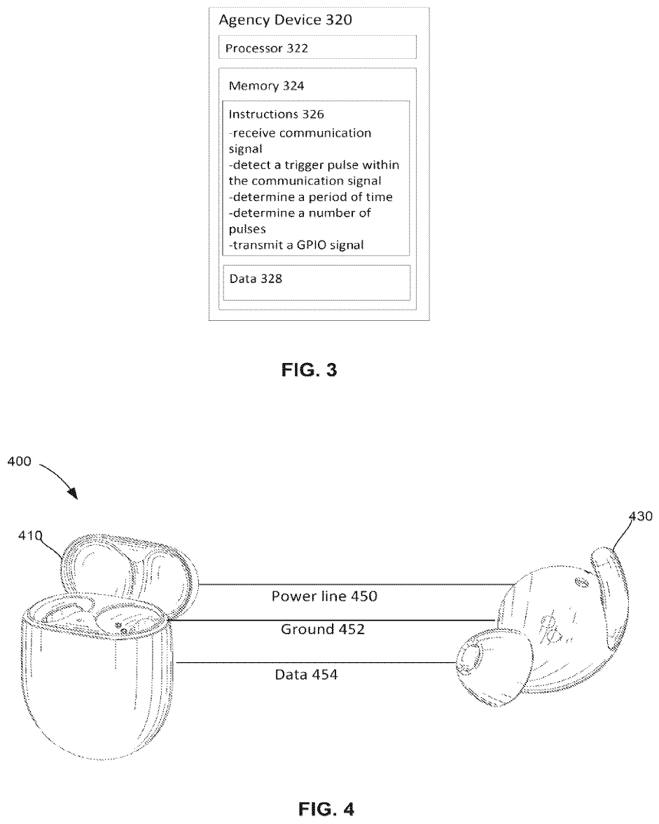

FIG. 4 illustrates another system of example devices in which the features described herein may be implemented. System 400 includes charging case 410 and earbud 430. Charging case 410 may be the control device and earbud 430 may be the controlled device. While only one earbud 430 is shown, there may be a pair of earbuds that fit within charging case 410. Each of the charging case 410 and earbud 430 may include an agency device.

Charging case 410 and earbud 430 may be coupled via power line 450, data channel 454, and ground line 452. That is, FIG. 4 is different than FIG. 1 as there is a designated data channel 454 for data and/or communication signals to be sent between the charging case 410 and earbud 430. In FIG. 1, data and/or communication signals may be sent over the power line 150. While only one data channel 454 is shown, there may any number of data channels between the charging case 410, the control device, and the earbud 430, the controlled device.

The communication system between the charging case 410 and earbud 430 may additionally include a multiplexer and/or demultiplexer to enable half-duplex or full-duplex communication over the one or more data lines and/or power line.

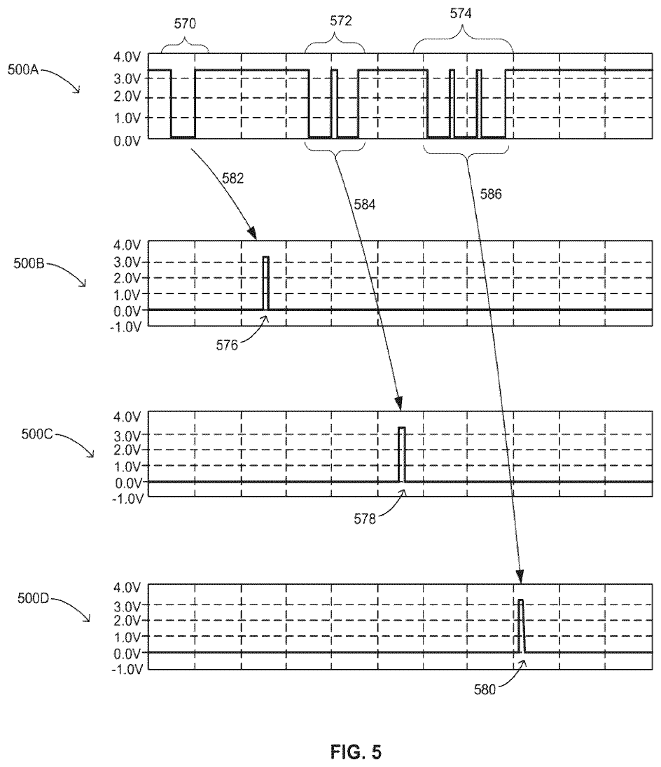

FIG. 5 illustrates a plurality of graphical representations of receiving and transmitting signals. For example, graph 500A illustrates the communication signals sent from the control device being received by the agency device. The power line may be set to maintain a high voltage, for example at 5V. The communication signal may include the control signal. According to some examples the communication signal may be a low signal state that is carried on a power line. The communication system may decode and/or demodulate the communication signal into a low pulse to be received by the agency device. According to some examples, the low pulse may have a minimum signal width of 500 microseconds. Having a high voltage power line and a control signal with a low pulse having a minimum signal width may allow the agency device to filter out the data being sent over the power line from control signals. This may prevent false triggering of the GPIO pins.

For example, the agency device may receive pulse 570 by decoding the power line communication signal. The window detection counter may begin counting the period of time once pulse 570 is received. The pattern counter may count the number of pulses during that period of time. The signal generator may transmit a signal to trigger a GPIO pin of the controlled device based on receiving one pulse during the period of time.

Graph 500B may correspond to a signal transmitted by the agency device to trigger a first GPIO. The agency device may transmit 582 a signal to the first GPIO pin based on the pattern counter counting only one signal 570, or pulse, during the period of time. The signal transmitted 582 to the first GPIO pin may trigger, or activate, the first GPIO pin.

Graph 500C may correspond to a signal transmitted by the agency device to trigger a second GPIO pin. The pattern counter may have counted two pulses during the time period starting when the window detection counter first received the signal. The agency device may transmit 584 a signal to the second GPIO pin based on the pattern counter counting two signals 572 during the period of time. The signal transmitted 584 to the second GPIO pin may trigger, or activate, the second GPIO pin.

Graph 500D may correspond to a signal transmitted by the agency device to trigger a third GPIO pin. The pattern counter may have counted three pulses during the time period starting when the window detection counter first received the signal. The agency device may transmit 586 a signal to the third GPIO based on the pattern counter counting three signals 574 during the period of time. The signal transmitted 586 to the second GPIO pin may trigger, or activate, the third GPIO pin.

According to some examples, triggering the first GPIO pin may result in the earbud entering debug accessory mode. In some examples, triggering the second GPIO pin may result in the earbud resetting. Triggering the first and third pin simultaneously may result in the earbud receiving a software update. Triggering the third pin, along, may raise or lower the playback volume. In some examples, triggering one of the GPIO pins may result in the earbud changing a radio frequency (“RF”) connectivity mode. These are merely some examples of what may happen once a GPIO pin is triggered. They are merely examples and are not intended to be limiting.

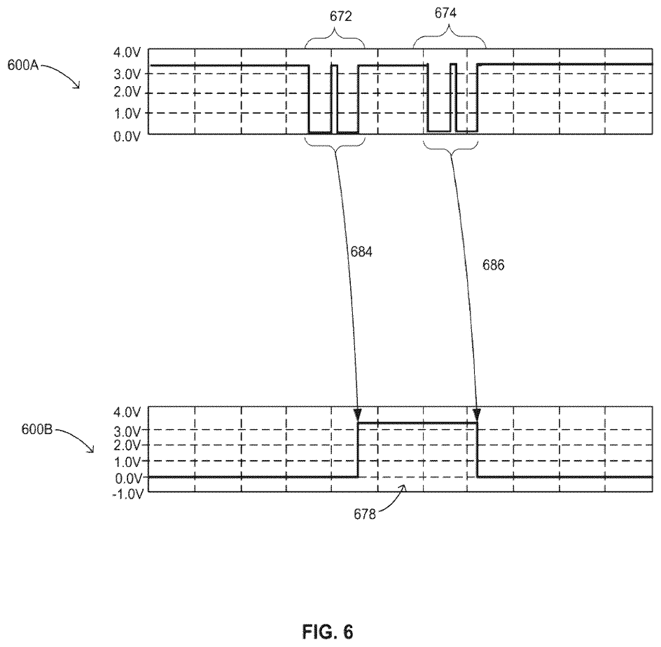

FIG. 6 illustrates another graphical representation of receiving and transmitting signals. For example, graph 600A illustrates the communication signals sent from the control device being received by the agency device. The communication signal may be a low pulse. The agency device may receive two pulses 672. The window detection counter may begin counting the period of time once the first pulse of pulses 672 is received. The pattern counter may count the two pulses during the time period starting when the window detection counter first received the first pulse of the signal. The agency device may transmit 684 a signal to a GPIO pin based on the pattern counter counting two signals 672 during the period of time. The signal transmitted 684 to the GPIO pin may trigger, or activate, the GPIO pin.

Graph 600B may correspond to the signal transmitted by the agency device to trigger the GPIO pin. The GPIO pin may maintain a high voltage 678 until the agency device sends a second signal. For example, after the period of time concludes and the signal is transmitted 684 to the GPIO pin, the detection window may detect another, or a new, signal. The detection window may restart the period of time once the first pulse of pulses 674 is received. The pattern counter may detect or count two pulses during the period of time. The agency device may transmit 686 a signal to the GPIO pin based on the pattern counter counting two signals 674 during the period of time. The signal transmitted 686 to the GPIO pin may trigger the GPIO pin to return to zero volts or a low voltage.

According to some examples, the agency device may receive control signals from another device. For example, the agency device may receive input provided by the user. The input may be a command, such as increasing or decreasing the volume, turning the controlled device on or off, etc.

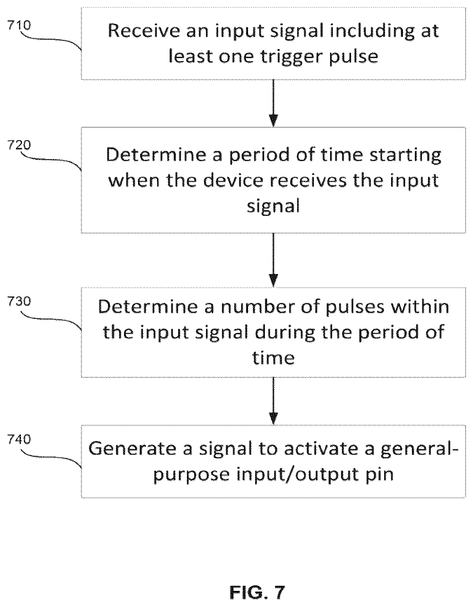

FIG. 7 illustrates an example method of an agency device triggering a GPIO pin on a controlled device based on a communication signal received from a control device. The following operations do not have to be performed in the precise order described below. Rather, various operations can be handled in a different order or simultaneously, and operations may be added or omitted.

In block 710, the agency device may receive an input signal from a control device. The input signal may be a communication signal. The input signal may include at least one trigger pulse.

In block 720, the agency device may determine a period of time starting when the agency receives the input signal. For example, the agency device may include a detection window counter. The detection window counter may begin counting the period of time to determine where the low pulse duration is longer than a predefined minimal signal width.

In block 730, the agency device may determine a number of pulses within the input signal during the period of time. For example, the agency device may include a pattern counter. The pattern counter may count the number of low pulses within the period of time. The pattern counter may count pulses with a certain signal width during the period of time. The signal width may be longer than a whole signal packet. This may ensure that the device does not malfunction for regular communication purposes.

In block 740, the agency device may generate a signal to activate a GPIO at a controlled device. The generated signal may be based on the counted number of pulses within the period of time. The number of pulses may correspond to a certain GPIO pin or function of the GPIO pin.

The technology described herein may be used for simplex, half duplex, and/or full-duplex signals. For example, a USB-C pinout may include a plurality of pins. One or more predefined pins may be used for debugging purposes. Many wearables and hearables may use sideband use (SBU) signals, such as SBU1 and/or SBU2. Additionally or alternatively, wearables and hearables may use USB signals. The USB pinout may need to support both orientations, SBU and USB. For example, if a smartphone uses the transmit and receive pins for high speed communications, the smartphone may use a high speed multiplexer to switch between the high speed communication signals and the debugging signals. In this example, the agency device, based on the received communication signals, may general and/or transmit a signal to one of the plurality of pins in the USB-C pinout. The signal may trigger the pin to perform a certain function.

The technology described herein is advantageous because it allows for triggering and, therefore, virtually enabling GPIO pins via a minimum number of communication lines, in particular less communication lines than GPIO pins that may be triggered signal-wise. Depending on different pulse patterns different GPIO pins are triggered without a need to actually physically provide all or any GPIO pins and individual communication lines connected to them. In particular, the technology described herein is thus advantageous because it may allow for the transmission of data over a power line, thereby minimizing the number of device contacts required for communication and power and power delivery between devices. The reduced number of contacts is due to having an agency device receive the communication signals sent from a control device. The agency device may count a number of pulses within the signal during a period of time. Based on the number of pulses, the agency device may generate and/or transmit a signal to the controlled device to trigger a certain GPIO pin. Using an agency device may negate the need for additional contacts between the control device and the controlled device. The reduced number of device contacts provides for efficiency in manufacture, better reliability, and ease of use, as well as reduced cost.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A device, comprising:
a detection window counter configured to determine a period of time, the period of time starting when the device receives an input signal including at least one trigger pulse;
a pattern counter configured to determine a number of pulses within the input signal during the period of time; and
a signal generator configured to generate a signal to activate a general-purpose input/output (“GPIO”) pin based on the determined number of pulses within the period of time.

2. The device of claim 1, wherein the signal generator is further configured to generate at least two different signals for activating at least two different GPIO pins based on different counted numbers of pulses within the period of time.

3. The device of claim 1, wherein the period of time is longer than a predefined minimal low pulse signal width.

4. The device of claim 1, wherein the device is capable of half-duplex or full-duplex communications.

5. The device of claim 1, wherein the pattern counter is further configured to determine a pulse width of a pulse within the period of time.

6. The device of claim 5, wherein the pattern counter is further configured to determine, based on the pulse width, a maximum quantity of pulses that occur during the period of time.

7. The device of claim 5, wherein the pulse width is larger than a whole signal packet.

8. A system, comprising:
a control device;
a controlled device; and
an agency device coupled to the control device and the controlled device, the agency device including:
a detection window counter configured to determine a period of time, the period of time starting when the agency device receives and input signal including at least one trigger pulse from the control device;
a pattern counter configured to determine a number of pulses within the input signal during the period of time; and
a signal generator configured to generate, based on the determined number of pulses within the period of time, a signal to activate a general-purposes input/output (“GPIO”) pin on the controlled device.

9. The system of claim 8, wherein the signal generator is further configured to generate at least two different signals to activate at least two different GPIO pins based on different counted numbers of pulses within the period of time.

10. The system of claim 8, wherein the period of time is longer than a predefined minimal low pulse signal width.

11. The system of claim 8, wherein the control device, the controlled device, and the agency device are capable of half-duplex or full-duplex communications.

12. The system of claim 8, wherein the pattern counter is further configured to determine a pulse width.

13. The system of claim 12, wherein the pattern counter is further configured to determine, based on the pulse width, a maximum quantity of pulses that occur during the period of time.

14. The system of claim 12, wherein the pulse width is larger than a whole signal packet.

15. A method, comprising:
receiving, by an agency device, an input signal from a control device, the input signal including at least one trigger pulse;
determining, by the agency device, a period of time, the period of time starting when the agency device receives the input signal including the at least one trigger pulse;
determining, by the agency device, a number of pulses within the input signal during the period of time; and
generating, by the agency device and based on the determined number of pulses within the period of time, a signal to activate a general-purposes input/output (“GPIO”) pin at a controlled device.

16. The method of claim 15, wherein generating the signal to activate the GPIO pin further includes generating, by the agency device, at least two different signals to activate at least two different GPIO pins based on different counted numbers of pulses within the period of time.

17. The method of claim 15, wherein the agency device is capable of half-duplex of full-duplex communications.

18. The method of claim 15, further comprising determining, by the agency device, a pulse width.

19. The method of claim 18, further comprising determining, by the agency device and based on the pulse width, a maximum quantity of pulses that occur during the period of time.

20. The method of claim 18, wherein the pulse width is larger than a whole signal packet.
